(19) United States
(12) Patent Application Publication
(10) Pub. No.: US 2015/0004291 A1
(43) Pub. Date: Jan. 1, 2015

(54) HONEY CUBE

(71) Applicant: Mohammad a.m.s.h. Alzemi, Kuwait City (KW)

(72) Inventor: Mohammad a.m.s.h. Alzemi, Kuwait City (KW)

(21) Appl. No.: 13/928,469

(22) Filed: Jun. 27, 2013

(51) Int. Cl. A23L 1/08

(52) U.S. Cl. CPC A23L 1/08
USPC 426/281; 426/576

(57) ABSTRACT

A honey gelatin product for use as a sweetener and the like comprises or consists of about one teaspoon of filtered alfalfa honey added into an animal gelatin cube of bovine gelatin that is solidified as for example a relatively generally cubic shaped lozenge. The invention also contemplates making a honey gelatin product for use as a sweetener that includes the step of providing a mass of clover honey and a smaller mass of liquid bovine gelatin. The honey is heated to a temperature of up to about 40° C. and filtered to remove impurities and prevent beading or removal of any existing beading therefrom. The honey is injected into the animal gelatin cube with additional herbs cooled to about 20° C. and packaged and placed into a dark covered sealed container.

### FIELD OF THE INVENTION

This invention relates to a honey/gelatin food product and more particularly to honey cubes for sweetening hot beverages as for example tea and coffee. The invention also relates to a method for preparing honey sweeteners.

### BACKGROUND OF THE INVENTION

Honey is a sweet food made by bees using nectar from flowers. Honey also has a long history of human consumption and has been widely used as a sweetener and for flavoring. The flavoring varies based on the nectar gathered by the bees.

Gelatin is a translucent colorless flavorless solid substance derived from the collagen inside animal skin and bones. It is commonly used as a gelling agent in food and pharmaceuticals. Gelatin is a mixture of peptides and protein produced by partial hydrolysis of collagen. Gelatin is an irreversibly hydrolised form of collagen and is classified as a food stuff, with #E441. It is also well known that there are two types of gelatin, an animal and a plant based gelatin. In the present invention, animal gelatin is preferred because it is easy to be collected and it contains some nutritional (amino acids) values too. Further, plant source gelatins are difficult to obtain and more expensive.

Products for containing honey are widely used, for example a U.S. Pat. No. 4,804,542 of Fischer et al. discloses a gelatin capsules that includes a capsule sheath and a capsule filling. The capsule sheath consists of gelatin and additional additives while the filling mainly includes 85% honey and 15% glycerol. The resulting product was a solid and storage staple gelatin capsule.

An antiulcer agent containing honey in a gelatin capsule is disclosed in a U.S. Pat. No. 6,815,419 to Hayasawa et al. As disclosed therein, the anti-ulcer agent can be mixed with honey and prepared with a gelatin capsule coating.

Finally, a U.S. Pat. No. 7,851,458 of Stone discloses a cartilage enhancing food supplement and methods of preparing the same. As disclosed, a snack bar in accordance with the aforementioned patent may include several additional ingredients and discloses the use of honey as a wetting agent for use in the Stone invention.

In contrast to the above, the present invention contemplates honey inside of a gelatin cube that comprises or consists of gelatin cubes filled with honey and preferably a bovine gelatin cube to be utilized as a sweetener for hot beverages such as tea and coffee. The honey cube is intended to be used as a sweetener and not as a therapeutic product. It should be recognized that cow gelatin is an incomplete protein and is used in the present invention for its benefits. These benefits are obtained because it contains essential amino acids and is rich in glycerin and pralines.

It is presently believed that the honey cubes in accordance with the present invention will facilitate the use of honey in place of sugar. It is believed that avoiding the use of sugar will lead to a healthier lifestyle, avoid a cause of childhood obesity and avoid problems as with diabetes.

Accordingly, it is presently believed that there may be a demand for the honey cubes in accordance with the present invention.

### BRIEF SUMMARY OF THE INVENTION

In essence, a honey/gelatin food product in accordance with the present invention comprises or consists of 1 ml to 5 ml of honey that is infused into a cube of gelatin as for example, animal gelatin and solidified to a solid shaped product. In a preferred embodiment of the invention, the honey is clover honey. The reason for selecting clover honey is that it provides excellent sweetening properties without adding flavor. Accordingly, the hot tea or coffee flavor is maintained. One embodiment may also include small amounts of other ingredients as for example mint in amounts of not more than 0.5 wgt % of the honey.

The invention also contemplates a method of making a honey/gelatin food product. The method comprises or consists of providing a mass of clover, alfalfa or other honey and a liquid gelatin for example bovine; heating the mass of clover honey to a temperature of less than about 40° C. to preserve its nutrients; filtering the honey to remove impurities and to remove or prevent beading therein; the honey is then injected into the gelatin. Thereafter the filtered honey in gelatin is formed into a cube or other shape by adding the filtered honey in a mold in an amount of about ½ to one teaspoon of honey. The honey/gelatin product is then cooled to a temperature of about 20° C.; and packaged individually and finally into an appropriate package such as a sealed package with light protection.

### DESCRIPTION OF THE DRAWINGS

FIG. 1 is a flowchart of the steps in making a honey/gelatin product in accordance with the invention.

### DESCRIPTION OF THE PREFERRED EMBODIMENTS OF THE INVENTION

Honey is a sweet food made by bees using nectar from flowers the variety produced by honeybees (the genus APIS) is the one most commonly referred to and is the type of honey collected by bee keepers and consumed by humans. Honey produced by other bees has distinctly different properties.

Honey bees convert nectar into honey by a process of regurgitation and store it as a primary food source in wax honeycombs inside a beehive. Bee keeping practices encourage over production of honey so that the excess can be taken without endangering the bee colony.

Honey gets its sweetness from the monosaccharide, fructose and glucose and has approximately the same relative sweetness as that of granulated sugar. It has attractive chemical properties for baking and a distinctive flavor that leads some people to prefer it over sugar and other sweeteners. Most microorganisms do not grow in honey because of the very low water content (up to about 16%).

Honey has a long history of human consumption and is used in various foods and beverages as a sweetener and flavoring. It also has a role in religion and symbolism. Flavors of honey vary based on the nectar source and various types and grades of honey are available. It is also used in various medicinal traditions to treat ailments. The study of pollens and pores in raw honey (melissopalynology) can determine floral sources of honey.

Clover honey is a favorite choice for chefs for their baked foods and a fine table honey for tea lovers.

### Gelatin or Gelatine

Gelatin or gelatine is a translucent colorless brittle nearly tasteless solid substance derived from the collagen inside animals' skin and bones. It is commonly used as a gelling agent in food, pharmaceuticals and in cosmetic manufacturing. Substances containing gelatin are functioning in a similar way are called gelatiness. Gelatin is an irreversibly hydrolyzed form of collagen and is classified as a food stuff with E441. It is found in some gummy candies as well as other products such as marshmallows, gelatin desert and some low fat yogurt.

To be more specific, gelatin is a protein produced by partial hydrolyses of collagen extracted from the boiled bones, connected tissue, organs and some intestines of animals such as domesticated cattle and horses. The natural molecular bonds between individual collagen strands are broken down into a form that rearranges more easily. Gelatin melts to a liquid when heated and solidifies when cooled again. Together with water, it forms a semi-solid colloid gel. Gelatin forms a solution of high viscosity and water and sets to a gel on cooling. Its chemical composition are in many respects closely similar to that of its parent collagen.

Cow gelatin, also known as hydrolyzed fresh cow collagen powder is made of fresh Bovine skin through pretreatment and biodegradation of the collagen with biological enzyme. The micro molecular collagen polypeptide has a mean molecular weight of less than 3,000. It contains the total amino acids and has the advantage of good nutritive value, high absorption, water solubility, stability and moist-retention quality.

The present invention also contemplates the addition of certain herbs including basil, cilantro, mint, rosemary, sage and tarragon. These herbs may be added to the honey in amounts of up to about 5% by weight.

A honey gelatin product for use as a sweetener according to the invention includes about 1 to 5 ml or up to about one teaspoon of clover, alfalfa or other honey that is injected into a gelatin cube. In the preferred embodiment of the invention the liquid gelatin is animal or hydrolyzed Bovine gelatin.

In a second embodiment of the invention, the honey in a gelatin capsule, perhaps in the shape of a relatively large lozenge or generally hexagonal or oval shape.

In practice, the honey is heated to about 40° C. but less than 40° C. to preserve its nutrients. The honey is filtered through one or more filters having a conventional pore size or opening to remove any and all impurities and prevent the formation of beading or to remove any existing beading from the honey.

At this stage the heated honey is infused or injected into a cube of solidified liquid bovine gelatin.

In addition to the above, it is contemplated that while the honey cubes should not need any preservatives, in cases when it is desired to extend the shelf life some preservatives can be added such as citric acid. The suggested shelf life in the present case is one year but could be extended with the use of appropriate preservatives.

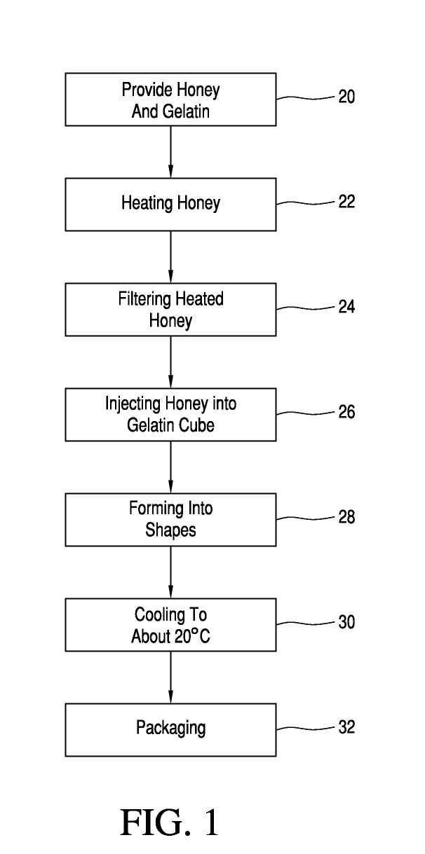

A method for producing a honey/gelatin sweetener will now be described in connection with FIG. 1. A first step 20 calls for providing a mass of honey and gelatin which will be maintained in separate containers or the like. In a second step 22 the honey is heated in a filling machine at about 35° C. but not exceeding 40° C. and the heated honey is filtered in a third step 24. The gelatin is formed into empty cubes by conventional techniques in much the same way that capsules are formed and the mold is cooled to about 20° C. The heated honey is then infused or injected into a gelatin capsule. After infusing the gelatin cube with honey the honey surrounded by gelatin is formed into a preselected shape as for example by placing it into a mold in step 28. The mold is then cooled to about 20° C. in step 30, packaged in step 32 as for example in light paper by taking a volume of about one teaspoon of the cooled honey to about 20° C. or less and packaged in an amount of about one teaspoon per package and being wrapped with paper and placed in a dark colored sealed container as for example a dark plastic or glass.

Advantageously, the use of the honey cube in accordance with the present invention is particularly applicable as a sweetener for hot beverages.

The shapes of the honey cubes can be changed as required. For example, one alternative is a hexagonal shape. Such shapes can be used to indicate that this cube contains honey. The shape could also be designed in the ball shape to make it look like children's candy. Nevertheless, it preferably has a distinctive shape to avoid it from medicines.

An additional advantage of the present invention resides in the avoidance of the use of liquid honey. The honey cubes in accordance with the invention replace liquid honey that can be spilled on a hospital bed or the like by a patient who may not be steady. Thus, the honey cubes overcome the need to replace bed clothes and hospital bedding.

While the invention has been disclosed in connection with its preferred embodiments it should be recognized that changes and modifications may be made therein without departing from the scope of the claims.

What is claimed is:

1. A honey gelatin product for use as a sweetener, said product including about one teaspoon of filtered honey injected into a cube of solidified gelatin and wherein said cube shaped gelatin is solidified hydrolyzed bovine gelatin.

2. A honey gelatin product according to claim 1 in which said honey is selected from the group of alfalfa and clover honey and in which said gelatin is hydrolyzed bovine gelatin.

3. A honey gelatin product according to claim 3 in which said honey is heated to a temperature of up to 40° C. but not exceeding 40° C., filtering said heated honey to remove any impurities and to prevent beading or removing any beading therefrom, cooling said honey to about 20° C. and forming a preselected shape, cooling said shape of infused honey and storing and packaging said product.

4. A honey gelatin product according to claim 3 in which said product is packaged and stored in an airtight dark colored glass container.

5. A method for making a honey gelatin product comprising the steps of:
providing a mass of alfalfa honey and infusing said honey into a solid cubic shaped capsule of hydrolyzed bovine gelatin, packaging in paper and placing the paper wrapped gelatin coated honey in a sealed dark container.

6. A method for making a honey gelatin product consisting of the steps of:
providing a mass of alfalfa honey and a mass of hydrolyzed bovine gelatin;
heating said mass of alfalfa honey to a temperature of up to 40° C.;
filtering said heated honey to remove impurities and to prevent beading therein or to remove any beading therefrom;
forming a cubic shaped capsule of said hydrolyzed bovine gelatin;
injecting said honey into said solidified liquid bovine gelatin;
cooling said honey/gelatin product to a temperature of about 20° C.; and
packaging said honey gelatin product in paper and placing it in a sealed dark colored container.

7. A honey gelatin product for use as a sweetener, said product consisting of:
about one teaspoon of filtered honey and a cube shaped capsule of solidified gelatin surrounding said honey and wherein said honey is clover honey and said gelatin is hydrolyzed bovine gelatin.
